(19) United States
(12) Patent Application Publication
(10) Pub. No.: US 2006/0026242 A1
(43) Pub. Date: Feb. 2, 2006

(54) Messaging spam detection

(75) Inventors: John Henry Kuhlmann, Carnation, WA (US); Eric Edgar Lofdahl, Kent, WA (US); Curtis L. Miller, Sammamish, WA (US); David N. Hoogerwerf, Snohomish, WA (US); Kristine G. Siebert, Issaquah, WA (US); Larry A. Setlow, Redmond, WA (US); Alan C. Lindsey, Edmonds, WA (US)

Correspondence Address: DARBY & DARBY P.C., P. O. BOX 5257, NEW YORK, NY, 10150-5257, US

(73) Assignee: Wireless Services Corp

(21) Appl. No.: 10/902,799

(22) Filed: Jul. 30, 2004

(51) Int. Cl. G06F 15/16

(52) U.S. Cl. 709/206

(57) ABSTRACT

Detecting unsolicited messages (spam) by aggregating information across multiple recipients and/or across the same or differing messaging protocols. Multiple messages are analyzed to detect a call to action pattern that specifies a target communication address with which the recipients are requested to communicate, such as an email address, an Internet address, a telephone number, and the like. Once a frequency threshold of messages containing the call to action pattern is reached, subsequent messages are temporarily quarantined for evaluation by a human operator. If the human determines that the messages are not spam, the human can release the quarantined messages, and indicate that future messages with the call to action pattern are not to be delayed. Conversely, if the human determines that the messages are spam, the human can delete the messages in quarantine, and indicate that all future messages with that call to action pattern are to be deleted automatically.

### FIELD OF THE INVENTION

The present invention is directed to controlling unsoliticted messages, commonly referred to as spam, and more specifically to detecting unsolicited messages transmitted to multiple recipients according to one or more protocols within communication services and between communication services.

### BACKGROUND OF THE INVENTION

Text messages have become an increasingly popular method of communication, especially with mobile devices such as cellular telephones, personal data assistants (PDAs), and the like. Such messages are generally inexpensive to send and receive relative to some voice communications, graphics-intensive communications, and other forms of communication that require a large amount of communication resources. Messages can be exchanged across a variety of protocols, including those for web-based message portals, telephones, and email systems.

Because messages can be transmitted easily, a significant risk exists that unsolicited messages will be sent to client devices. In addition to consuming communication resources, spam can create additional expenses for recipients, including time and inconvenience. To protect their clients from these expenses, some messaging network providers perform spam filtering. As spam purveyors create more sophisticated methods to avoid detection, the spam filtering systems must become more sophisticated.

### BRIEF DESCRIPTION OF THE DRAWINGS

FIG. 1 shows a functional block diagram of an exemplary server according to one embodiment of the invention;

FIG. 2 is a functional block diagram illustrating an overall architecture of an exemplary embodiment of the present invention; and

FIG. 3 is a flow diagram illustrating exemplary logic for evaluating a message to determine whether it is spam.

### DETAILED DESCRIPTION OF THE INVENTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.”

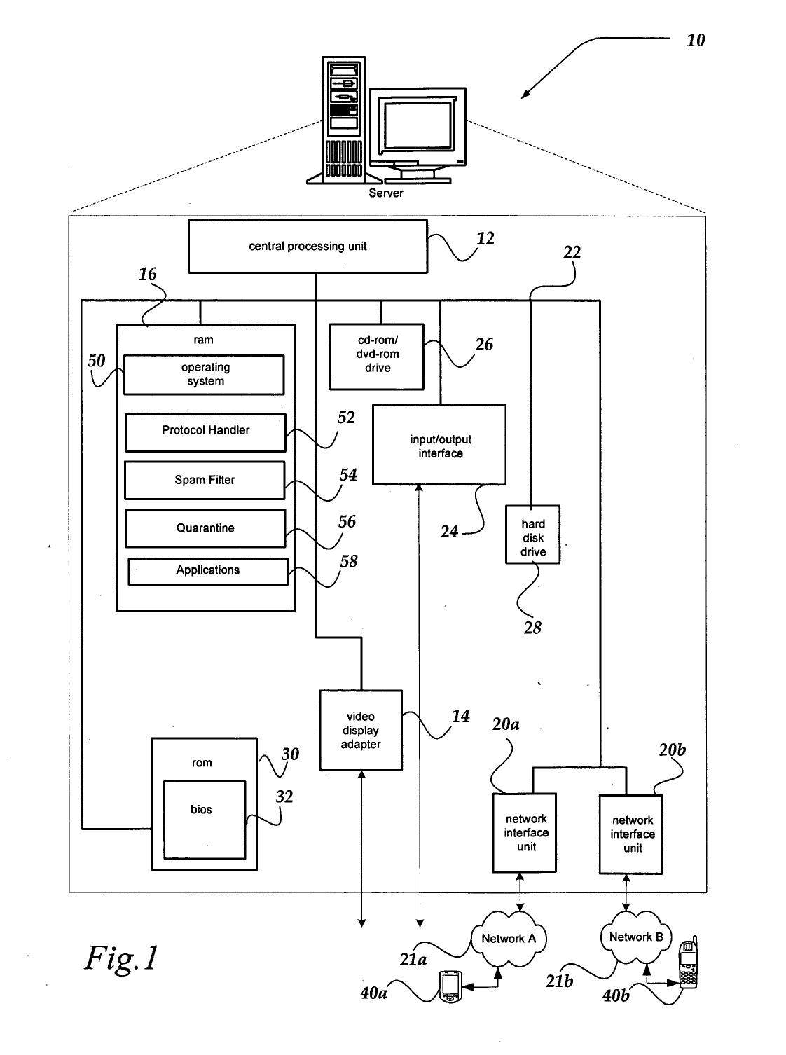

Briefly stated, the invention is direct to a method and system for detecting and controlling spam by adaptively aggregating information about messages to multiple recipients, including messages communicated across multiple protocols. FIG. 1 shows a functional block diagram of an exemplary server 10, according to one embodiment of the invention. In general, server 10 is a typical modern server computer, and may have many high performance components to provide the necessary performance to handle millions of messages daily. Thus, server 10 may include many more components than those shown. The components shown, however, are sufficient to disclose an illustrative embodiment for practicing the invention. Client devices can be similarly configured. Client devices can include, but are not limited to, other servers, personal computers (PCs), PDAs, mobile terminals (e.g., cell phones), unified mail systems, and the like. A recipient can also receive messages via other forms of communication, such as fax, voice mail, postal mail, and the like.

Server 10 includes a processing unit 12, a video display adapter 14, and a mass memory, all in communication with each other via a bus 22. The mass memory generally includes RAM 16, ROM 30, and one or more permanent mass storage devices, such as an optical drive 26, a hard disk drive 28, a tape drive, and/or a floppy disk drive. The mass memory stores an operating system 50 for controlling the operation of server 10. Any general-purpose operating system may be employed. A basic input/output system (“BIOS”) 32 is also provided for controlling low-level operation of server 10.

The mass memory also includes computer-readable media, sometimes called computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 58 are loaded into mass memory and run on operating system 50. Examples of application programs include database programs, schedulers, transcoders, email programs, calendars, web services, word processing programs, spreadsheet programs, and so forth. Mass storage may further include applications such as a request handler 52 for managing communication requests from senders, an authenticator for authenticating a sender, a message transmitter 56 for communicating with a recipient, and the like.

Server 10 also includes input/output interface 24 for communicating with external devices, such as a mouse, keyboard, scanner, or other input devices not shown in FIG. 1. Server 10 can communicate with the Internet, a telephone network, or other communications network via network interface units 20a and 20b, which are constructed for use with various communication protocols including transmission control protocol/Internet protocol (TCP/IP), user datagram protocol (UDP), and the like. Network interface units 20a and 20b are sometimes known as transceivers, transceiving devices, network interface cards (NICs), and the like. Multiple private and public portals and/or other network services can communicate through these interface cards, and can communicate messages with the server through a variety of higher level protocols including, but not limited to, simple mail transfer protocol (SMTP), T1 access partitioning (TAP) protocol, simple network paging protocol (SNPP), hypertext transfer protocol (HTTP), multimedia messaging service (MMS) protocol, instant messaging and presence protocol (IMPP), and the like. The network interface units can facilitate inter-carrier communications between networks that conform to the same or differing communication protocols. For example, network interface unit 20a is illustrated as communicating with a network A 21a, such as a network that communicates messages according to the wireless access protocol (WAP), or the like. Network A 21a provides communication services for conforming client devices, such as a PDA/Phone 40a. Similarly, network interface unit 20b is illustrated as communicating with a network B 21b, such as a network that communicates messages according to the short message protocol (SMS), or the like. Carrier network B 21b provides communication services for conforming client devices, such as a cellular phone 40b.

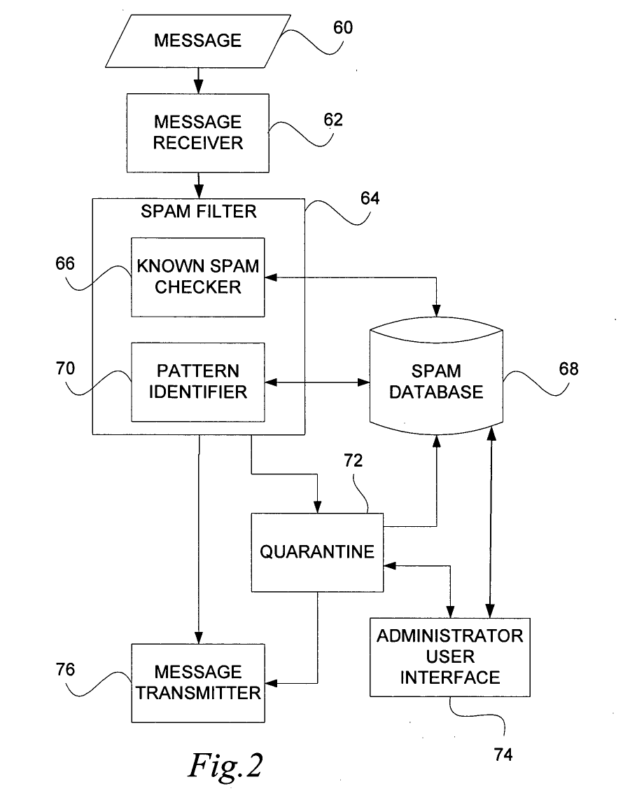

FIG. 2 is a functional block diagram illustrating an overall architecture of an exemplary embodiment of the present invention. A message 60 is received by a message receiver 62. The message generally comprises delivery information and message content. The delivery information includes a delivery destination recipient, or multiple delivery destination recipients. If the recipient has not solicited this message, or if the message does not come from a trusted source, the message might be spam. However, an unsolicited message, or a message from an unknown source is not always spam. Another determining aspect is whether a recipient desired the message. In general, whether the recipient desired the message is completely subjective. Nevertheless, the spam detection system of the present invention is capable of identifying messages that may likely be spam, based on information detected in messages to multiple recipients, which is not generally known to individual recipients.

Message receiver 62 is configured to receive messages conforming to at least one of a plurality of communication protocols. There may be multiple message receivers, each corresponding to a different communication protocol. Alternatively, message receiver 62 can be a central receiver that can detect and conform to the protocol of an incoming message. Message receiver 62 engages in a protocol-specific interchange with the sender, and converts the message into a format that is compatible with a spam filter 64.

Spam filter 64 includes one or more modules that can evaluate the content of the message for spam. For instance, a known spam checker 66 can evaluate the content of individual message 60 for known indicators of spam such as a known spammer's email address, a portion of content likely to indicate a spam message (e.g., the word Viagra), a network domain or address known to be a source of spam, and the like. Known spam checker 66 should not be considered limited to currently known techniques for detecting spam. Instead, known spam checker 66 determines whether a message includes a previously identified indication of spam messages. Known spam checker 66 includes a user interface that enables an administrator to enter known spam information such as the types of information listed above. The administrator can also enter a range of IP addresses to filter any and all messages coming from sources within the range of IP addresses. The spam information is stored in a spam database 68 that is in communication with known spam checker 66.

Spam filter 64 also includes a pattern identifier 70, which tracks information over a number of messages to identify patterns that are not detectable by looking at a single message alone. For example, pattern identifier 70 can detect that a number of messages have a sequence of target addresses, phone numbers, and the like, which indicates that an automated system sent messages to a sequence of target recipients. Pattern identifier 70 can also detect a large number of messages coming from a single source, which suggests a new source of spam. Conversely, pattern identifier 70 can detect a large number of messages sent to a single target, which suggests a denial of service attack. A number of other techniques can be used individually, or in combination, to analyze multiple messages and assess whether the messages comprise spam. Some of the techniques include detecting a large number of recipients in a message, detecting a large number of repeated words in a message, detecting a long source address, and detecting other characteristics. The characteristics can be statistically analyzed, such as with Bayesian techniques. Alternatively, or in addition, the characteristics can be assigned weighted scores, voted on, or otherwise evaluated for indications of spam.

Call to Action Frequency Detection

The intent of many spam messages is to cause the recipient to take some action such as visit a website, call an operator, go to a nightclub, or the like. In order to induce such action, the spam message must include a “call to action” with sufficient information that the recipient can take the spammer's desired action. Pattern identifier 70 is capable of recognizing classes of call to action patterns, including Uniform Resource Locators (URLs), domain names, IP addresses, email addresses, text message addresses, phone numbers, fax numbers, push-to-talk addresses, or any other call to action pattern with defined and understood characteristics. In addition to identifying identical call to action patterns in multiple messages, pattern identifier 70 can evaluate sets of call to action patterns for equivalency. For example, a URL in each individual message may change slightly, but pattern identifier 70 can consider them to be part of the same call to action pattern for detection and blocking purposes. Call to action patterns, in addition to having consistent characteristics, generally consist of a communication technology value that is independent of local human languages and/or human symbologies such as number systems. Although different localities may have some differing communication technologies, such as different phone number patterns, a minimum of localization is required to allow pattern identifier 70 to detect a call to action pattern in any locale or human language.

Pattern identifier 70 can automatically notify a human operator and direct them to evaluate one or more messages that fall within one of the detected patterns to determine whether the pattern represents spam messages. One or more messages that conform to a detected pattern can be stored by a quarantine module 72 that is in communication with spam filter 64 and spam database 68. Quarantine module 72 temporarily stores messages for a human operator to evaluate, and processes messages that the human operator does not have time to evaluate. The human operator can interact with quarantine module 72 through an administrator user interface 74. The human operator can also use administrator user interface 74 to interact with spam database 68 to manually enter and/or modify information related to spam detection.

Non-spam messages that were temporarily quarantined, or that previously passed through spam filer 64, can be released for delivery by a message transmitter 76 to one or more service carriers that can deliver the messages to target client devices. As with the message receiver, message transmitter 76 conforms to at least one of a plurality of communication protocols. There may be multiple message transmitters, each corresponding to a different communication protocol. Alternatively, message transmitter 76 can be a central transmitter that can detect and conform to the protocol(s) of the intended service carrier(s). If necessary, message transmitter 76 can convert the content of an outgoing message to a format that is compatible with protocol(s) of the intended service carrier(s).

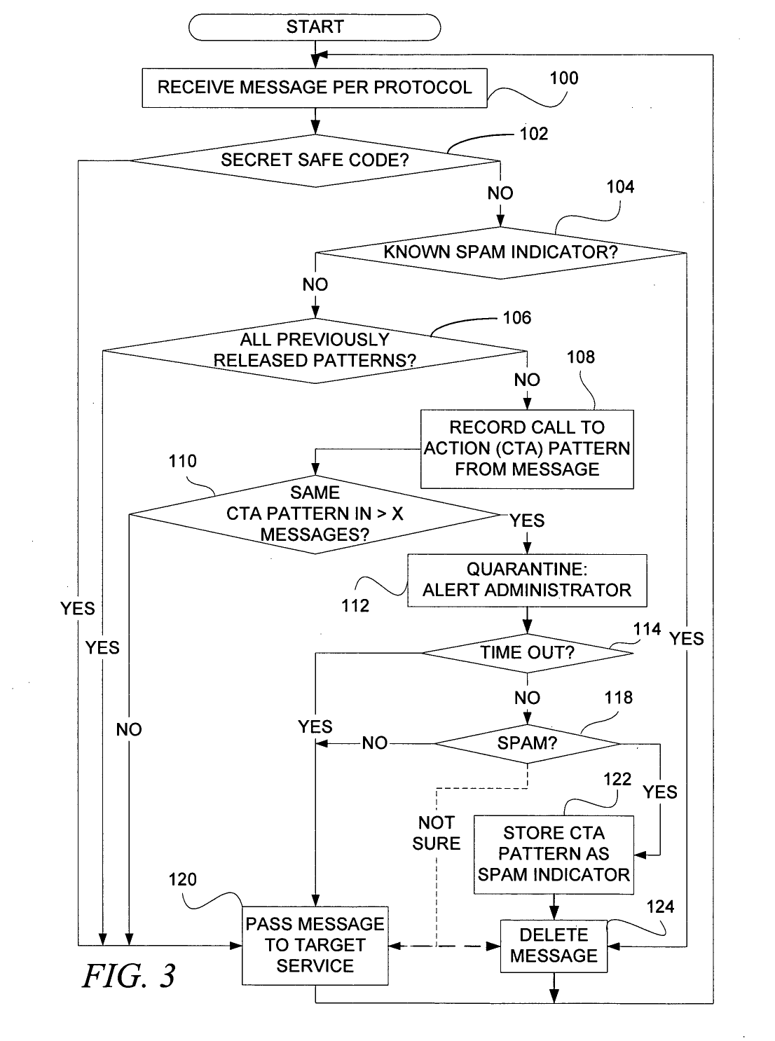

FIG. 3 is a flow diagram illustrating exemplary logic for filtering messages for spam. At an operation 100, the message receiver receives an inbound message conforming to the corresponding message protocol, such as an email protocol, a mobile messaging protocol, a paging message protocol, and the like. The message receiver performs the protocol-specific interaction with the sender to construct an entire message. The message receiver converts the message to a common format that other processing modules can understand. A single format can be used for all processing modules, or multiple formats can be used for different processing modules. The message receiver can also parse the message header and/or content for further modular processing.

Secret Password

At a decision operation 102, the spam filter determines whether the message includes a secret safe code that a recipient, enterprise, and/or service has selected to indicate that the message is not spam. For example, a receiving enterprise can specify a password, an encoded value, or other special content that is used to inform the spam filter that a bulk message is not spam to all members of the enterprise. Alternatively, an individual recipient can specify a secret safe code, that the recipient can distribute to those individuals and/or message sources from which the recipient is willing accept messages. The spam filter can access the spam database to determine whether the secret safe code is associated with the recipient, and if so, immediately release the message for delivery to the recipient.

The spam filter can also refer to ists of safe contacts (sometimes referred to as white lists) in the spam database, so that the spam filter will not consider as spam messages received from members of the safe contact lists. White lists may be defined for individual recipients, a group or recipients, and/or all recipients. Messages from white listed contacts skip the remaining spam detection processing and are passed to a target carrier service, at an operation 120, for delivery to the recipient's client device.

If the received message does not include a safe code, safe contact, or the like, the spam filter determines whether the message includes a known spam indicator at a decision operation 104. For example, the spam filter can compare the message sender address to a list of stored addresses known to distribute spam (sometimes referred to as a black list). In addition, the spam filter parses the message for call to action patterns and determines whether the message includes a call to action pattern that was previously identified as an indicator of spam. For instance, the spam filter can compare a URL in the message to a list of URLs that were previously identified as call to actions patterns of spam messages conforming to the same or different message protocols. If the message includes a known spam indicator, such as a black listed sender address or a previously determined call to action, the spam filter deletes the message at an operation 124.

If the message does not include a known spam indicator, the spam filter determines whether the message comprises only previously released patterns at a decision operation 106. If the spam filter or a human operator previously analyzed a detected pattern and determined that the pattern does not indicate spam, the pattern can be stored in the database with an indication that subsequent messages including the pattern need not be delayed or deleted. Subsequent messages that include multiple patterns can be released automatically at operation 120 if all of the patterns in the message were previously determined not to indicate spam.

A previously released call to action pattern is distinguished from a widely recognized pattern that some filtering systems consider a white list entry. For example, some filtering systems consider a URL to a well known retail Web site as an indication that the message is not spam. In these filtering systems, the well known retail Web site is part of a predefined white list. However, clever spammers can exploit these widely recognized patterns by including them in spam messages to slip through filtering systems that include widely recognized patterns in a white list. The present invention does not include a predefined white list of widely recognized patterns that would be considered safe codes. Instead, the present invention treats a widely recognized pattern as a potential indicator of spam until the spam filter or human operator analyzes the widely recognized pattern and determines that it is not a call to action that indicates spam. These widely recognized patterns can then be added to the data base of previously released patterns. If a subsequent message includes only previously released patterns (or no patterns), the subsequent message can be release automatically at operation 120.

If the message includes a call to action pattern that was not previously released and was not affirmatively identified as an indicator of spam, the pattern is stored for further comparison with other messages at an operation 108. For each message that includes the same call to action pattern, a count is incremented for this pattern. At a decision operation 110, the spam filter determines whether the detected call to action pattern was found in more than a threshold number (X) of messages. This number can be based actual messages received and/or a single message that is addressed to a threshold number of recipients. In addition, or alternatively, this decision can be based on other evaluations, such as statistical analyses, voting, and the like.

One such evaluation includes detecting a consistent sequence of call to action patterns. For example, a number of messages might include a domain name that differs in a consistent or inconsequential manner. To illustrate this situation, a sample sequence of domain names is listed below:
www.random_word_A1.random_word_B.domain.com
www.random_word_A2.random_word_B.domain.com
www.random_word_A3.random_word_B.domain.com
www.random_word_A4.random_word_B.domain.com
   The above samples include a sequentially incrementing random word in a portion of the domain name, but they all specify the same domain type (e.g., .com). A corresponding domain name service (DNS) could resolve the sequence of domain names to a single network and/or device, which could be the directed destination of spam. As another example, a sequence of consistently or inconsequentially changing domain names may specify the same file name, which may also suggest spam.

In any case, as long as the call to action pattern is found in fewer than the threshold number of messages, the current message is passed to the target service at operation 120. Although analysis of the message thus far in the process may suggest a likelihood that the message is spam, the message is not considered spam unless the threshold frequency is reached for the detected call to action pattern. The frequency can be adjusted to modulate spam detection relative to traffic loads and/or for other reasons.

Reaching a threshold frequency does not necessarily ensure that the call to action pattern indicates spam. When the number of messages and/or recipients associated with a given call to action pattern exceeds the adjustable threshold, the message containing this call to action pattern is quarantined at an operation 112, and the spam detection system sends a notification message to one or more human operators. The notification identifies the message, the message content, the call to action pattern, the frequency of the call to action pattern, and/or other information. A human operator responds by reviewing the quarantined message and subsequent messages with the same call to action pattern that may have arrived after quarantine was imposed. The administrator is given a limited time to evaluate the message to prevent undue delay in delivering the message, especially an instant message, an SMS message, or other near-real-time message. This time limitation can be adjusted or determined based on message characteristics, such as the type of message, the source of the message, the target service, a paid priority level, and the like.

At a decision operation 114, the spam filter determines whether the allowed time has lapsed. If the allowed time has lapsed, the message is passed to the target service at operation 120 for delivery to the intended recipient's client device. Until the pattern is determined to be a spam indicator, or not, by a human operator, messages that contain the pattern will continue to be quarantined for the time limit, and, if not acted upon, released to be delivered.

If the administrator reviews the quarantined message within the time limit, the administrator determines at a decision operation 118 whether the message is spam. If the administrator concludes that the message is not spam or that the call to action pattern is not a good indicator of spam, the administrator can flag the call to action pattern, so that the spam filter will not use that pattern to subsequently divert messages to quarantine.

If the administrator is not certain whether the message is spam, the administrator can manually release the message for delivery without flagging and/or storing the call to action pattern. Any subsequent message with the same call to action pattern would again be quarantined for another review. Conversely, the administrator can manually delete the message, or group of messages with the same call to action pattern. Again, a subsequent message with the same call to action pattern would be quarantined for another review. However, if the administrator indicates with certainty that the message is spam, and/or that the call to action pattern is a good spam indicator, the spam filter stores the call to action pattern as a spam indicator at an operation 122. All messages in quarantine that contain that call to action pattern are then deleted at operation 122. The call to action pattern is automatically loaded into the database and subsequent messages with that call to action pattern will be automatically deleted without human intervention. After the message is deleted or passed to the target service, control returns to operation 100 to await another message.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for detecting an unsolicited message, comprising:
detecting a call to action pattern in a message received according one of a plurality of communication protocols;
determining that the call to action pattern is included in a number of other received messages that exceeds a threshold number;
temporarily preventing the message from being delivered; and
notifying a human operator to review the message to determine whether the message comprises an unsolicited message.

2. The method of claim 1, wherein the call to action pattern comprises at least one of a universal resource locator (URL), an email address, a text message address, a telephone number, a fax number, a push-to-talk address, and an Internet protocol (IP) address.

3. The method of claim 1, further comprising determining that the message does not include content selected by a user to indicate that the message should be delivered without review by the human operator.

4. The method of claim 1, further comprising determining that the message does not include data known to indicate an unsolicited message.

5. The method of claim 1, further comprising releasing the message for delivery after a delay period.

6. The method of claim 5, further comprising automatically indicating that subsequent messages that include the call to action pattern will be released without being temporarily prevented from delivery.

7. The method of claim 1, further comprising determining that the call to action pattern was not previously identified for release without delay.

8. The method of claim 1, further comprising enabling the human operator to indicate that the call to action pattern shall cause subsequent messages that include the call to action pattern to be one of:
released without delay; and
deleted.

9. The method of claim 1, further comprising:
detecting that one portion of the call to action pattern is the same in previously received messages; and
detecting that another portion of the call to action pattern differs in at least one of a consistent and an inconsequential manner from the previously received messages.

10. The method of claim 1, wherein the other received messages were received according to at least one different communication protocol from the one of the plurality of communication protocols according to which the message was received.

11. The method of claim 1, wherein the plurality of communication protocols support at least one of short message service, mail management system, instant messaging, and multimedia message service.

12. A system for detecting an unsolicited message, comprising:
a processor;
a communication interface in communication with the processor and in communication with at least one network conforming to at least one of a plurality of communication protocols;
a user interface in communication with the processor and enabling a human operator to review and input information; and
a memory in communication with the processor and storing data and instructions that cause the processor to perform a plurality of operations including:
detecting a call to action pattern in a message received according the at least one of the plurality of communication protocols;
determining that the call to action pattern is included in a number of other received messages that exceeds a threshold number;
temporarily preventing the message from being delivered; and
notifying a human operator to review the message to determine whether the message comprises an unsolicited message.

13. The system of claim 12, wherein the call to action pattern comprises at least one of a universal resource locator (URL), an email address, a text message address, a telephone number, a fax number, a push-to-talk address, and an Internet protocol (IP) address.

14. The system of claim 12, wherein the instructions further cause the processor to perform the function of releasing the message for delivery after a delay period.

15. The system of claim 14, wherein the instructions further cause the processor to perform the function of automatically indicating that subsequent messages that include the call to action pattern will be released without being temporarily prevented from delivery.

16. The system of claim 12, wherein the instructions further cause the processor to perform the function of determining that the call to action pattern was not previously identified for release without delay.

17. The system of claim 12, wherein the instructions further cause the processor to perform the function of enabling the human operator to indicate through the user interface that the call to action pattern shall cause subsequent messages that include the call to action pattern to be one of:
released without delay; and
deleted.

18. The system of claim 12, wherein the instructions further cause the processor to perform the functions of:
detecting that one portion of the call to action pattern is the same in previously received messages; and
detecting that another portion of the call to action pattern differs in at least one of a consistent and an inconsequential manner from the previously received messages.

19. A system for detecting spam, comprising:
a message receiver that can receive a message according to at least one of a plurality of communication protocols;
a spam filter in communication with the message receiver and detecting a call to action pattern in the message and in at least one other message; and
a quarantine module that enables a human operator to determine whether the message is spam.

20. The system of claim 19, further comprising a message transmitter that can transmit the message to a communication service for delivery to an intended recipient, wherein the message receiver is in communication with a first network and the message transmitter is in communication with a second network.
